(19) United States
(12) Patent Application Publication
(10) Pub. No.: US 2016/0198099 A1
(43) Pub. Date: Jul. 7, 2016

(54) DISPLAY APPARATUS AND DISPLAYING METHOD THEREOF

(71) Applicant: SAMSUNG ELECTRONICS CO., LTD., Suwon-si (KR)

(72) Inventors: Kyeong-a Han, Suwon-si (KR); Hee-jeong Bae, Osan-si (KR)

(73) Assignee: SAMSUNG ELECTRONICS CO., LTD., Suwon-si (KR)

(21) Appl. No.: 14/987,402

(22) Filed: Jan. 4, 2016

(30) Foreign Application Priority Data
Jan. 2, 2015 (KR) 10-2015-0000194

(51) Int. Cl. H04N 5/262; H04N 5/445; H04N 5/44

(52) U.S. Cl. CPC H04N 5/2624; H04N 5/2628; H04N 5/4403; H04N 5/44513; H04N 5/44543; H04N 5/44582; H04N 5/44591; H04N 2005/4412; H04N 2005/4416; H04N 2005/443; H04N 2005/44521

(57) ABSTRACT

A display apparatus and a displaying method thereof are provided. The display apparatus includes a display configured to display a first screen, a second screen, and a highlight on the first screen, the first screen including a first user interface (UI). The display apparatus further includes an input interface configured to receive a first selection of a first button of the input interface, and a second selection of a second button of the input interface, and a controller configured to, in response to the input interface receiving the first selection of the first button while the highlight is displayed on the first screen, control the display to display the highlight on the first UI, and in response to the input interface receiving the second selection of the second button while the highlight is displayed on the first UI, control the display to display the highlight on the first screen.

### CROSS-REFERENCE TO RELATED APPLICATION

This application claims priority from Korean Patent Application No. 10-2015-0000194, filed on Jan. 2, 2015, in the Korean Intellectual Property Office, the disclosure of which is incorporated herein by reference in its entirety.

### BACKGROUND

1. Field

Apparatuses and methods consistent with exemplary embodiments relate to a display apparatus and a displaying method thereof, and more particularly, to a display apparatus configured to display a plurality of contents simultaneously, and control the displayed contents effectively, and a displaying method thereof.

2. Description of the Related Art

A display apparatus is used not only to display broadcast contents but also to serve as a central device by being connected to various peripheral apparatuses. In addition, a display apparatus allows users to watch various contents on websites via an Internet connection. A display apparatus such as a TV has been advanced to a smart TV by installing various applications, thereby enhancing its usability.

With such technological developments of a display apparatus, resolution of the display apparatus has also been enhanced. As an example, an Ultra High Definition (UHD) display apparatus has been introduced. The UHD refers to the resolution of 3840×2160 pixels. As the resolution has increased, the size of a display apparatus has also been enlarged.

Accordingly, there have been increasing user needs for displaying various contents simultaneously on a large-sized display screen and controlling and using the displayed contents in various ways. Thus, a method to satisfy the user needs is desired.

### SUMMARY

Exemplary embodiments address at least the above problems and/or disadvantages and other disadvantages not described above. Also, one or more exemplary embodiments are not required to overcome the disadvantages described above, and an exemplary embodiment may not overcome any of the problems described above.

Aspects of one or more exemplary embodiments provide a display apparatus capable of displaying a plurality of contents simultaneously, and controlling the displayed contents effectively, and a displaying method thereof.

According to an aspect of an exemplary embodiment, there is provided a display apparatus including a display configured to display a first screen, a second screen, and a highlight on the first screen, the first screen including a first user interface (UI). The display apparatus further includes an input interface configured to receive a first selection of a first button of the input interface, and a second selection of a second button of the input interface, and a controller configured to, in response to the input interface receiving the first selection of the first button while the highlight is displayed on the first screen, control the display to display the highlight on the first UI, and in response to the input interface receiving the second selection of the second button while the highlight is displayed on the first UI, control the display to display the highlight on the first screen.

The controller may be further configured to, in response to the input interface receiving the second selection of the second button while the highlight is displayed on the first screen, control the display to enlarge a size of the first screen, and display the enlarged first screen on a full area of the display.

The first UI may include a second UI, and the controller may be further configured to, in response to the input interface receiving the first selection of the first button while the highlight is displayed on the first UI, control the display to display the highlight on the second UI.

The input interface may be further configured to receive a control command, and the controller may be further configured to, in response to the input interface receiving the control command while the highlight is displayed on the first screen, perform a function corresponding to the control command with respect to the first screen, and in response to the input interface receiving the control command while the highlight is displayed on the first UI, perform the function with respect to the first UI.

The input interface may be further configured to receive a command to move the highlight, and the controller may be further configured to, in response to the input interface receiving the command to move the highlight while the highlight is displayed on the first screen, control the display to display the highlight on the second screen.

The second screen may include another UI, and the controller may be further configured to, in response to the input interface receiving the first selection of the first button while the highlight is displayed on the second screen, control the display to display the highlight on the other UI, and in response to the input interface receiving the second selection of the second button while the highlight is displayed on the other UI, control the display to display the highlight on the second screen.

The input interface may be further configured to receive a command to display the first screen and the second screen simultaneously, and the controller may be configured to, in response to the input interface receiving the command to display the first screen and the second screen simultaneously while the first screen is displayed on a full area of the display, control the display to display the first screen and the second screen simultaneously, and display the highlight on the first screen.

The input interface may be further configured to receive a command to display the first screen and the second screen simultaneously, and the controller may be configured to, in response to the input interface receiving the command to display the first screen and the second screen simultaneously while the first screen is displayed on a full area of the display and the highlight is displayed on the first UI, control the display to display the first screen and the second screen simultaneously, and display the highlight on the first UI.

The input interface may include an external control apparatus configured to control the display apparatus, and the first button and the second button may be at least one among toggle buttons, key buttons, and touch buttons on the external control apparatus.

The input interface may be further configured to receive a command to change the second screen, the controller may be further configured to, in response to the input interface receiving the command to change the second screen, control the display to display a menu and the highlight on the menu, the input interface may be further configured to receive a command to select the menu, and the controller may be further configured to, in response to the input interface receiving the command to select the menu while the highlight is displayed on the menu, control the display to display a third screen.

According to an aspect of another exemplary embodiment, there is provided a displaying method of a display apparatus, the displaying method including displaying a first screen, a second screen, and a highlight on the first screen, the first screen including a first user interface (UI). The method further includes, in response to receiving a first selection of a first button of an input interface while the highlight is displayed on the first screen, displaying the highlight on the first UI, and in response to receiving a second selection of a second button of the input interface while the highlight is displayed on the first UI, displaying the highlight on the first screen.

The method may further include, in response to receiving the second selection of the second button while the highlight is displayed on the first screen, enlarging a size of the first screen, and displaying the enlarged first screen on a full area of the display.

The first UI may include a second UI, and the method may further include, in response to receiving the first selection of the first button while the highlight is displayed on the first UI, displaying the highlight on the second UI.

The method may further include, in response to receiving a control command while the highlight is displayed on the first screen, performing a function corresponding to the control command with respect to the first screen, and in response to receiving the control command while the highlight is displayed on the first UI, performing the function with respect to the first UI.

The method may further include, in response to receiving a command to move the highlight while the highlight is displayed on the first screen, displaying the highlight on the second screen.

The second screen may include another UI, and the method may further include, in response receiving the first selection of the first button while the highlight is displayed on the second screen, displaying the highlight on the other UI, and in response to receiving the second selection of the second button while the highlight is displayed on the other UI, displaying the highlight on the second screen.

The displaying the first screen and the second screen may include, in response to receiving a command to display the first screen and the second screen simultaneously while the first screen is displayed on a full area of the display, displaying the first screen and the second screen simultaneously, and displaying the highlight on the first screen.

The displaying the first screen and the second screen may include, in response to receiving a command to display the first screen and the second screen simultaneously while the first screen is displayed on a full area of the display and the highlight is displayed on the first UI, displaying the first screen and the second screen simultaneously, and displaying the highlight on the first UI.

The method may further include, in response to receiving a command to change the second screen, displaying a menu and the highlight on the menu, and in response to receiving a command to select the menu while the highlight is displayed on the menu, displaying a third screen.

### BRIEF DESCRIPTION OF THE DRAWINGS

The above and/or other aspects of the present inventive concept will be more apparent by describing exemplary embodiments of the present inventive concept with reference to the accompanying drawings, in which:

FIG. 1 is a block diagram illustrating a display apparatus, according to an exemplary embodiment;

FIGS. 2A, 2B, and 2C are views illustrating a display screen of a display apparatus, according to an exemplary embodiment;

FIGS. 3A, 3B, and 3C are views illustrating a method of moving a highlight and releasing a mode in which a plurality of screens are displayed, according to an exemplary embodiment;

FIGS. 4A, 4B, and 4C are views illustrating a method of moving a highlight, according to an exemplary embodiment;

FIGS. 5A and 5B are views illustrating a method of displaying a highlight when a user command to display a plurality of screens is input, according to an exemplary embodiment;

FIGS. 6A, 6B, and 6C are views illustrating a method of replacing a web page screen that is displayed with another content or program simultaneously, according to an exemplary embodiment;

FIG. 7 is a view illustrating a control apparatus to control a display apparatus, according to an exemplary embodiment;

FIG. 8 is a view illustrating a control GUI to control a display apparatus, according to an exemplary embodiment; and

FIG. 9 is a flowchart illustrating a displaying method of a display apparatus, according to an exemplary embodiment.

### DETAILED DESCRIPTION OF EXEMPLARY EMBODIMENTS

Exemplary embodiments are described in greater detail with reference to the accompanying drawings.

The exemplary embodiments may vary, and may be provided in one or more different exemplary embodiments. However, this does not necessarily limit the scope of the exemplary embodiments to an exemplary embodiment form. Instead, modifications, equivalents and replacements included in the disclosed present inventive concept and technical scope of this specification may be employed.

In the present disclosure, relational terms such as first and second, and the like, may be used to distinguish one entity from another entity, without necessarily implying any actual relationship or order between such entities.

The terms used in the following description are provided to explain an exemplary embodiment and are not intended to limit the scope of rights. A singular term includes a plural form unless it is intentionally written that way. The terms, “include,” “comprise,” “is configured to,” etc. of the description are used to indicate that there are features, numbers, steps, operations, elements, parts or a combination thereof, and they do not exclude the possibilities of combination or addition of one or more features, numbers, steps, operations, elements, parts or a combination thereof.

In an exemplary embodiment, ‘a module’ or ‘a unit’ performs at least one function or operation, and may be realized as hardware, software, or combination thereof. In addition, a plurality of ‘modules’ or a plurality of ‘units’ may be integrated into at least one module and may be realized as at least one processor except for ‘modules’ or ‘units’ that are realized in specific hardware.

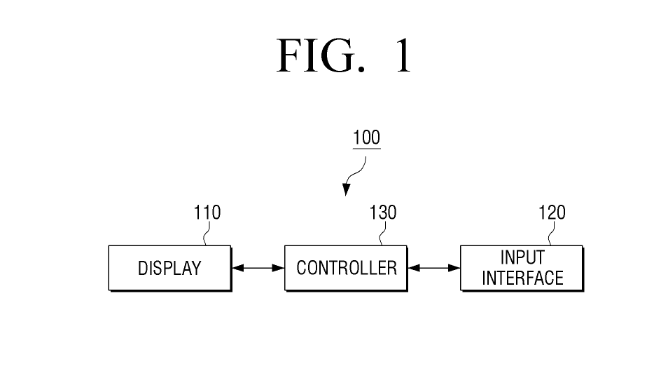

FIG. 1 is a block diagram illustrating a display apparatus 100, according to an exemplary embodiment. As illustrated in FIG. 1, the display apparatus 100 may include a display 110, an input interface 120 and a controller 130. In this case, the display apparatus 100 may be a TV, but this is only an example. The display apparatus 100 may be realized as various electronic apparatuses with the display 110, such as mobile phone, tablet PC, digital camera, camcorder, notebook PC, PDA, etc.

The display 110 displays an image. The display 110 may display contents that are received through a broadcast channel. In other words, the display apparatus 100 may receive various broadcast signals transmitted from a broadcasting station through an RF communication network, receive contents from various servers through an IP network, and display the received contents.

The display 110 may display a plurality of contents simultaneously. For example, if a user command to use two contents simultaneously is input, the display 110 may display two contents in the same or different size simultaneously.

The input interface 120 receives a user command. The input interface 120 may receive a user command that is input remotely. The input interface 120 may be realized as an apparatus including at least one of four direction buttons, a touch pad, and a motion sensor. For example, the input interface 120 may be realized as a remote controller, a mobile apparatus such as a smart phone, or a pointing device.

Alternatively, the input interface 120 may include a camera or various sensors separately. Accordingly, the input interface 120 may receive a user command through a user's movement that is photographed using a camera, or may receive a user command according to a result sensed by various sensors.

The controller 130 controls the overall operations of the display apparatus 100.

If a user command to display a second screen simultaneously is input while a first screen is displayed on the display 110, the controller 130 may control the display 110 to display the first screen, of which display size is reduced and where a highlight is displayed, and the second screen simultaneously.

If a first button of the input interface 120 is input while a highlight is displayed on the first screen, the controller 130 may control the display 110 to move the highlight included in the first screen to a first UI. If a second button of the input interface 120 is selected while the highlight is displayed on the first UI, the controller 130 may control the display 110 to move the highlight to the first screen.

If the second button of the input interface 120 is selected while the highlight is displayed on the first screen, the controller 130 may control the display 110 to enlarge the size of the first screen and display the first screen on the full area of the display 110.

If the first button of the input interface 120 is selected while the highlight is displayed on the first UI, the controller 130 may control the display 110 to move the highlight to a second UI that is a sub element of the first UI.

If a control command is input through the input interface 120 while a highlight is displayed on the first screen, the controller 130 may control a function with respect to the first screen, and if a control command is input through the input interface 120 while a highlight is displayed on the first UI, the controller 130 may control a function with respect to the first UI.

In other words, when a control command is input, the controller 130 may control a function corresponding to the input control command with respect to a screen where a highlight is displayed.

In addition, if a user command to move a highlight is input while the highlight is displayed on the first screen, the controller may control the display 110 to move the highlight to the second screen. For example, if a user command to select a left or right direction key is input through a remote controller to control the display apparatus 100 while a highlight is displayed on the first screen, the controller 130 may control the display 110 to move the highlight to the second screen.

If the first button of the input interface 120 is selected while a highlight is displayed on the second screen, the controller 130 may control the display 110 to move the highlight to the first UI included in the second screen, and if the second button of the input interface 120 is selected while a highlight is displayed on the first UI, the controller 130 may control the display 110 to move the highlight to the second screen.

If a user command to display the first screen and the second screen simultaneously is input through the input interface 120 while the first screen is displayed on the full area of the display 110, the controller 130 may control the display 110 to display the first screen and the second screen simultaneously while displaying a highlight on the first screen.

If a user command to display the first screen and the second screen simultaneously is input through the input interface 120 while a highlight is displayed on the first UI included in the first screen, the controller 130 may control the display 110 to display the first screen and the second screen simultaneously while displaying a highlight on the first UI included in the first screen.

The above-described first button and second button may be realized as a toggle button, a key button or a touch button on a separate control apparatus to control a display apparatus.

By using the above-described display apparatus 100, a user may use a plurality of contents simultaneously, and control the functions of each content easily.

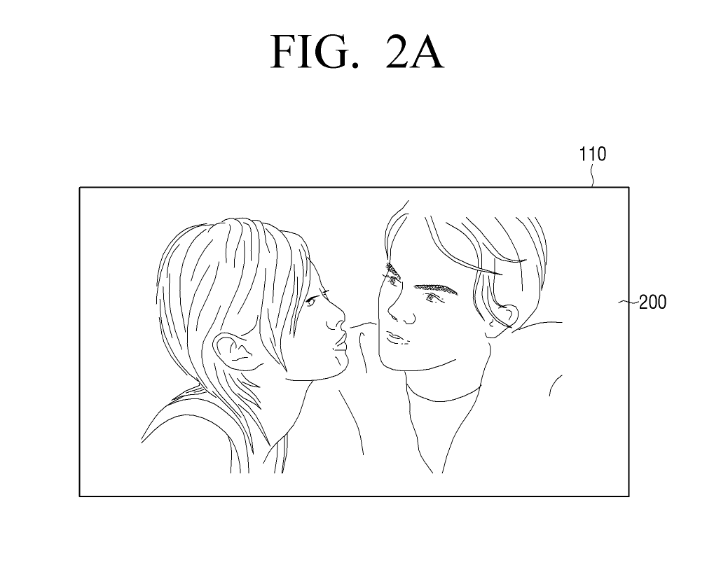

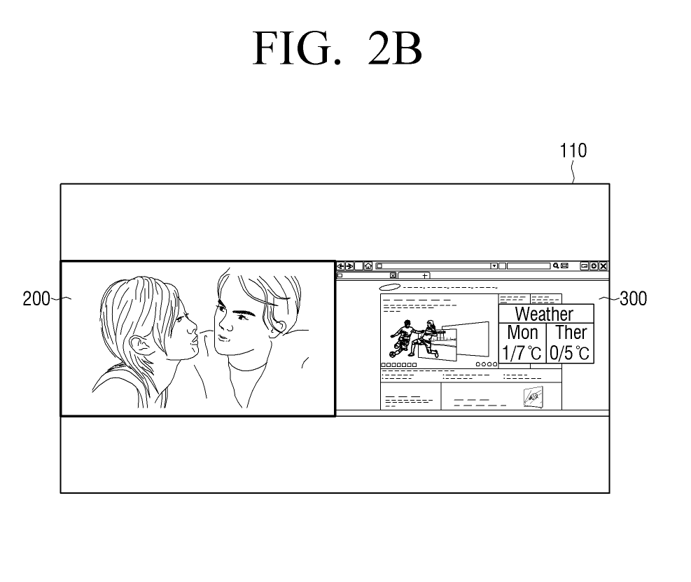

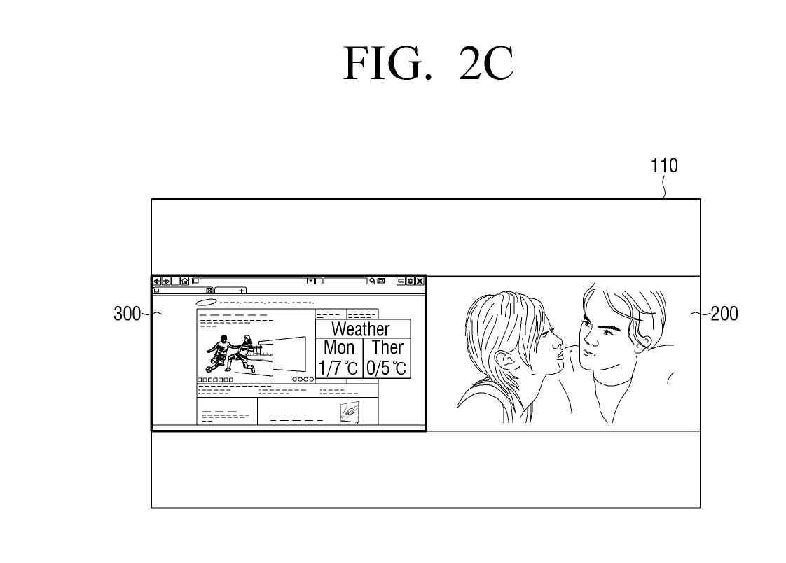

Hereinafter, a method for the controller 130 to display a plurality of images, a method of displaying a highlight indicating an image to be controlled, and a method of moving a displayed highlight will be described in detail with reference to FIGS. 2A to 8.

FIGS. 2A, 2B, and 2C are views illustrating a display screen of the display apparatus 100, according to an exemplary embodiment. FIG. 2A is a view illustrating that the display apparatus 100 displays a live-view image. For example, if the display apparatus 100 is realized as a TV, the controller 130 may control the display 110 to display a broadcast content screen 200 that is received through a broadcast channel as illustrated in FIG. 2A.

If a user command to display two images is input while a broadcast content is displayed, the controller 130 may control the display 110 to display the two contents simultaneously as illustrated in FIG. 2B.

The user command to display two images may be input by selecting a button that is provided separately on a control apparatus to control the display apparatus 100. For example, if a remote controller provides a button such as “mode,” a user may change to a mode in which the display apparatus 100 displays a plurality of images by pressing the button at least once.

In addition, the display apparatus 100 may display an On Screen Display (OSD) window. Accordingly, a user may change to a mode in which the display apparatus 100 displays two images through the displayed OSD window.

According to the above-described method, if a user command to display two contents is input while a broadcast content is displayed, the controller 130 may control the display 110 to display the broadcast content screen 200 and a web page screen 300 on the display 110 simultaneously as illustrated in FIG. 2B.

As further illustrated in FIG. 2B, the controller 130 may display a highlight on the broadcast content screen 200 that has been displayed before the user command to display a plurality of contents is input. For example, the controller 130 may display a highlight by displaying the outline of the broadcast content screen 200 in a thick line. However, displaying the outline of a screen in a thick line is only an example, and the controller 130 may display a highlight by applying a visual effect such that the broadcast content screen 200 seems to be protruded from the display 110 or by displaying an indicator around the broadcast content screen 200.

Displaying the web page screen along with the broadcast content screen 200 simultaneously is only an example, and the controller 130 may display a program or an application together when a user command to display a plurality of contents is input.

In addition, if a user command to display a plurality of contents is input, the controller 130 may display an application or a program that has been executed by a user most recently along with the broadcast content screen simultaneously.

FIG. 2C is a view illustrating the display 110 when a user command to display a plurality of contents is input while a web page is displayed on the full area of the display 110, according to an exemplary embodiment. For example, if a user command to display a broadcast content along with a web page is input from a user while the web page is being executed, the controller 130 may reduce the screen size of the web page that has been executed and display the web page screen 300 along with a highlight on the web page screen 300. Subsequently, the controller 130 may display the broadcast content screen 200 on the right side of the web page screen 300.

A user may move a highlight that is displayed. When a highlight is displayed by displaying the outline of the broadcast content screen 200 in a thick line, if a user command to move the highlight is input, the highlight may be moved, thereby displaying the outline of the web page screen 300 in a thick line.

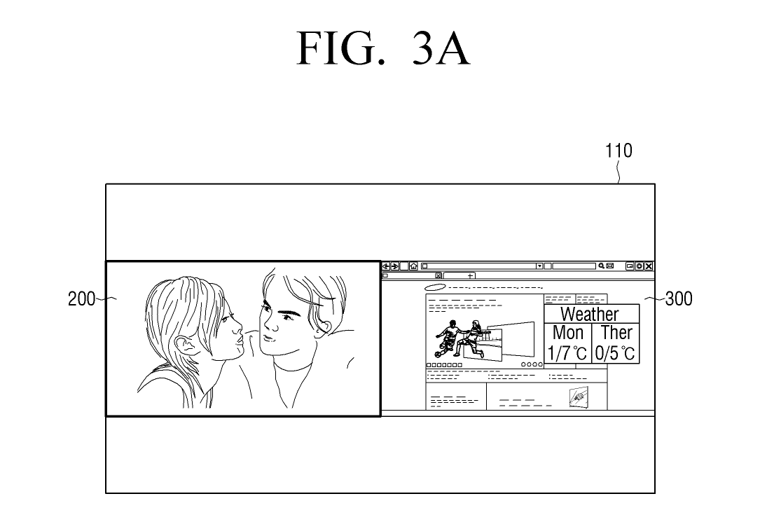

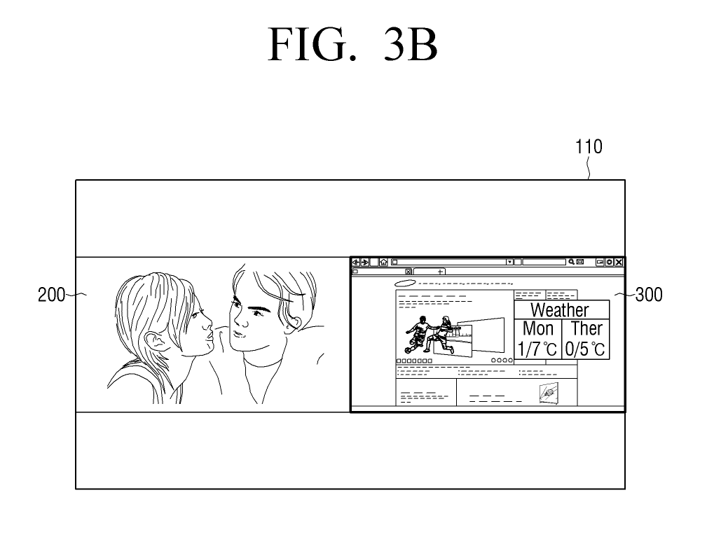

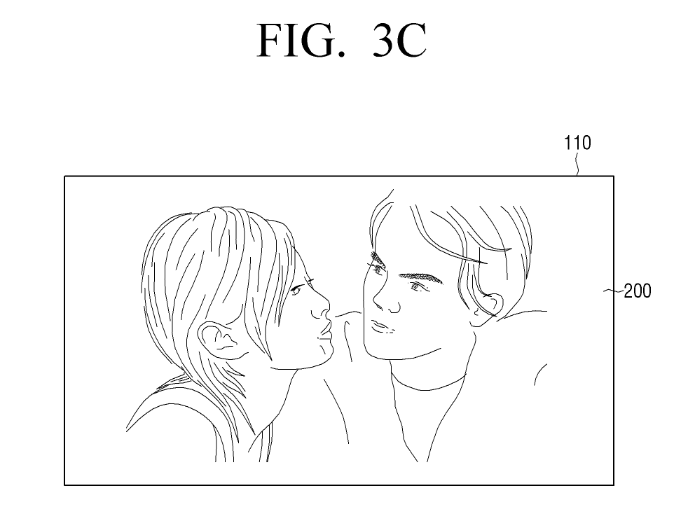

FIGS. 3A, 3B, and 3C are views illustrating a method of moving a highlight and releasing a mode in which a plurality of screens are displayed, according to an exemplary embodiment. FIGS. 3A and 3B are views illustrating an exemplary embodiment where a highlight is moved according to a user command. For example, if a user command to press a left or a right direction key among four direction keys provided on a remote controller is input, the thick line that is displayed on the outline of the broadcast content screen 200 may be released, and the highlight may be moved to the web page screen 300, thereby displaying the outline of the web page screen 300 in a thick line. However, moving a highlight with a left or a right direction key is only an example, and a user may move a highlight by using a touch input, a motion input, or a toggle key with directivity.

When two content screens are displayed simultaneously, a user may control a content where a highlight is displayed using an external control apparatus. In other words, as illustrated in FIG. 3A, when a highlight is displayed on the broadcast content screen 200, if a user command to press a channel or volume button provided on a remote controller is input, the channel or volume of a broadcast content can be controlled. Accordingly, a user may select a content to be controlled by moving a highlight.

If a mode for displaying a plurality of contents is released while a highlight is displayed on the broadcast content screen 200 (as illustrated in FIG. 3A), the controller 130 may display the screen where the highlight is displayed on the full area of the display 110. For example, if a user command to press ‘Exit’ button provided on a remote controller is input while a highlight is displayed on the broadcast content screen 200, the controller 130 may enlarge and display the broadcast content screen 200 on the full screen of the display 110 as illustrated in FIG. 3C.

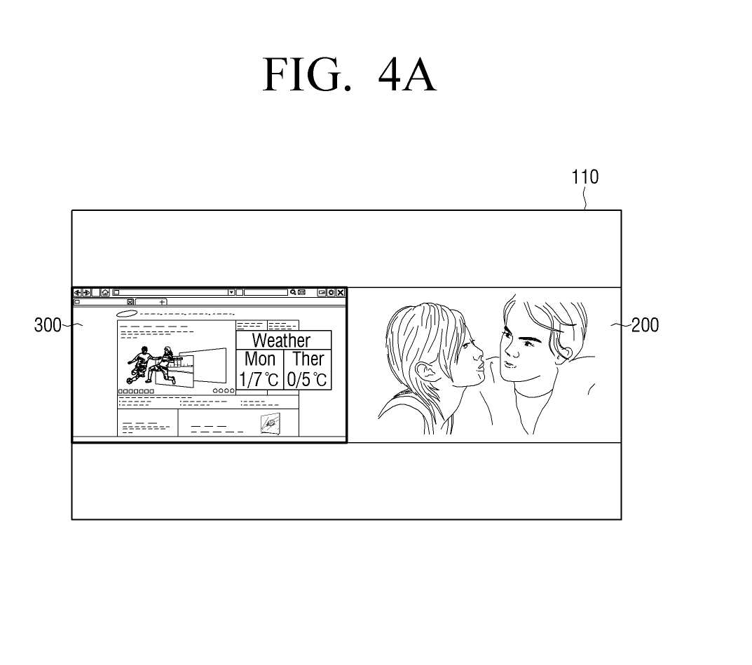

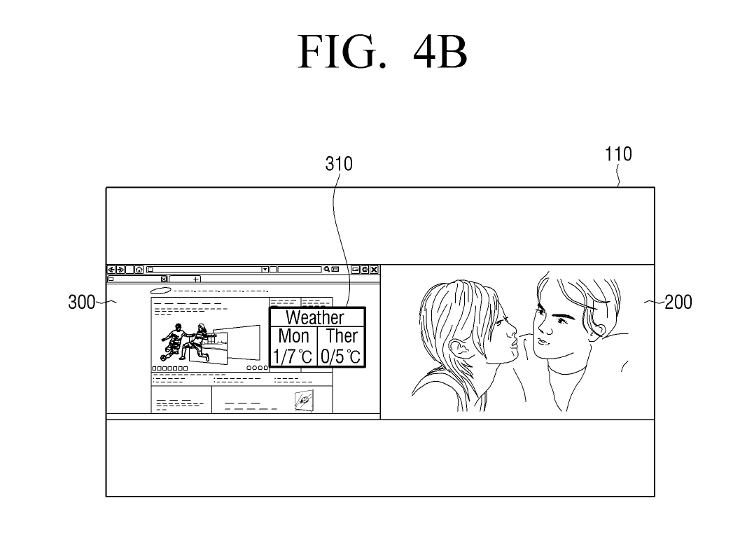

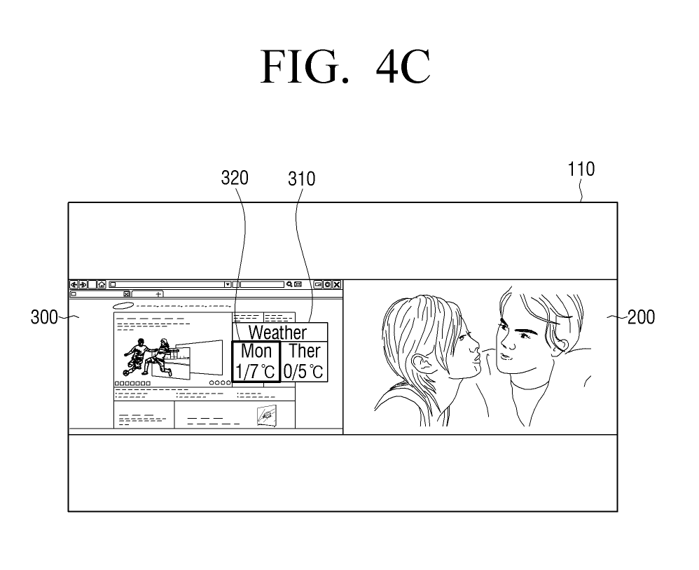

FIGS. 4A, 4B, and 4C are views illustrating a method of moving a highlight, according to an exemplary embodiment. FIG. 4A is a view illustrating an exemplary embodiment where the web page screen 300 and the broadcast content screen 200 are displayed simultaneously, and a highlight is displayed on the web page screen 300. The web page screen 300 may include an executable content, web page or program therein.

The controller 130 may adjust the depth of a highlight according to a user command. In other words, if a user command to select a content that is displayed on the web page screen 300 is input, the controller 130 may display a highlight on a controllable content among the contents included in the web page screen 300.

For example, as illustrated in FIG. 4B, when a content indicating weather is included in the web page screen 300, if a user command to press an “Enter” button provided on a remote controller is input, the controller 130 may move a highlight to the content 310 indicating weather. Accordingly, as illustrated in FIG. 4B, the thick line on the outline of the web page screen 300 may be released, and the highlight may be displayed on the weather content 310 in the web page screen 300, thereby displaying the outline of the weather content 310 in a thick line.

If the highlight is displayed on the weather content 310, and a user command to select the weather content 310 is input, the controller 130 enlarge a web page linked to the weather content 310 to the size of the web page screen 300 and display the weather content 310.

If there are a plurality of controllable contents in the web page screen 300, a user may move a highlight displayed in the webpage screen 300. For example, if a highlight is displayed on the weather content 310 in the web page screen 300, and a user command to press one of the direction keys provided on a remote controller is input, the controller 130 may display the highlight on another content in the web page screen 300 corresponding to the direction of the user command.

For example, FIG. 4C is a view illustrating an exemplary embodiment where a user command to select a content that is displayed in the weather content 310 is input. For example, if a user presses “Enter” button provided on a remote controller once again, the controller 130 may release the highlight that is displayed on the outline of the weather content 310 in a thick line, and may display the outline of an internal content 320 of the weather content 310 in a thick line.

If the highlight is displayed on the internal content 320 indicating the weather of Monday, and a user command to press “Enter” button one more time is input from a user, the controller 130 may enlarge a page linked to the weather of Monday to the size of the web page screen 300 and display the linked page.

If a user command to press “Exit” button is input while the highlight is displayed on the internal content 320 that indicates the weather of Monday as illustrated in FIG. 4C, the controller 130 may move the highlight back to the weather content 310 as illustrated in FIG. 4B.

If a user command to press “Exit” button is input once again while the highlight is displayed on the weather content 310 as illustrated in FIG. 4B, the controller may move the highlight back to the web page screen 300 as illustrated in FIG. 4A.

However, using “Enter” button and “Exit” button to control the depth of a highlight is only an example, and a user may control the depth of a highlight in various ways such as by inputting a touch command in different directions on a touch pad, or by using a pointing device or a toggle button, etc.

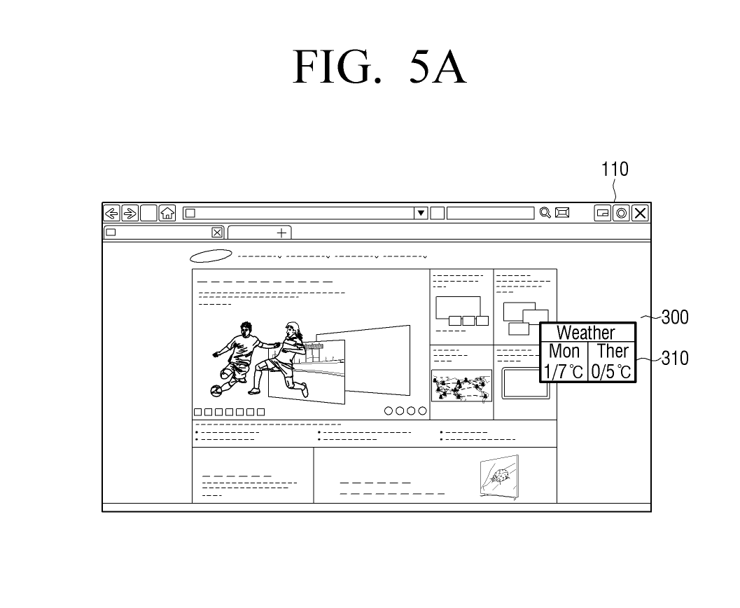

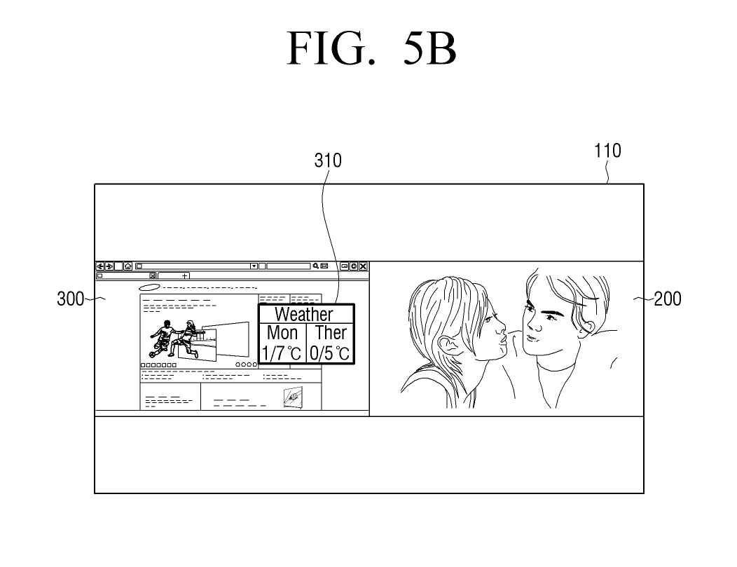

FIGS. 5A and 5B are views illustrating a method of displaying a highlight when a user command to display a plurality of screens is input, according to an exemplary embodiment. FIG. 5A is a view illustrating an exemplary embodiment where a highlight is displayed inside the web page screen 300 that is displayed on the full area of the display 110. In other words, FIG. 5A displays the web page screen 300 where a highlight of a thick line is displayed on the outline of the weather content 310.

If a user command to display a plurality of screens simultaneously is input while the highlight of a thick line is displayed on the outline of the weather content 310, the controller 130 may control the display 110 to reduce the size of the web page screen 300 while maintaining the highlight with respect to the weather content 310 in the web page screen 300 and display the reduced screen as illustrated in FIG. 5B. The controller 310 may display the reduced web page screen 300, where the highlight with respect to the weather content 310 is reduced, and the broadcast content screen 200 simultaneously. In other words, the user who controls the web page screen 300 or selects a content included in the web page screen 300 may control the web page screen 300 continuously by changing modes to display a plurality of contents.

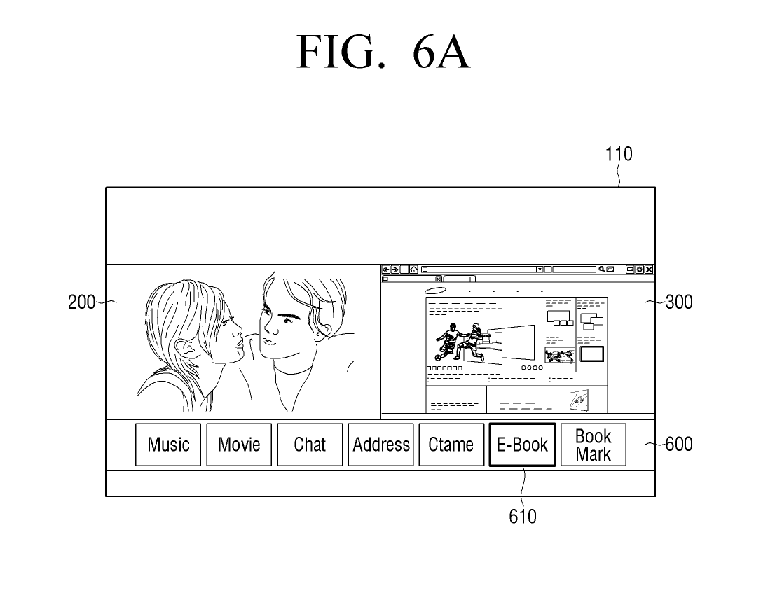

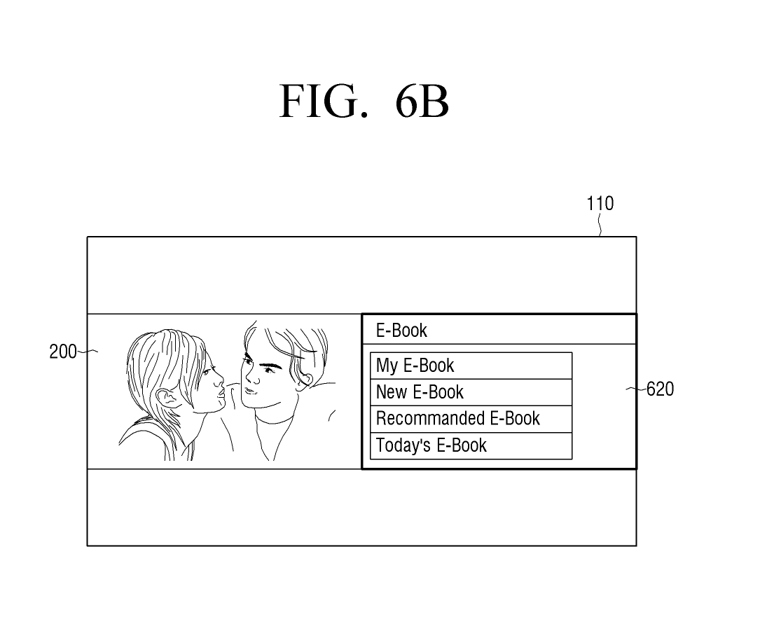

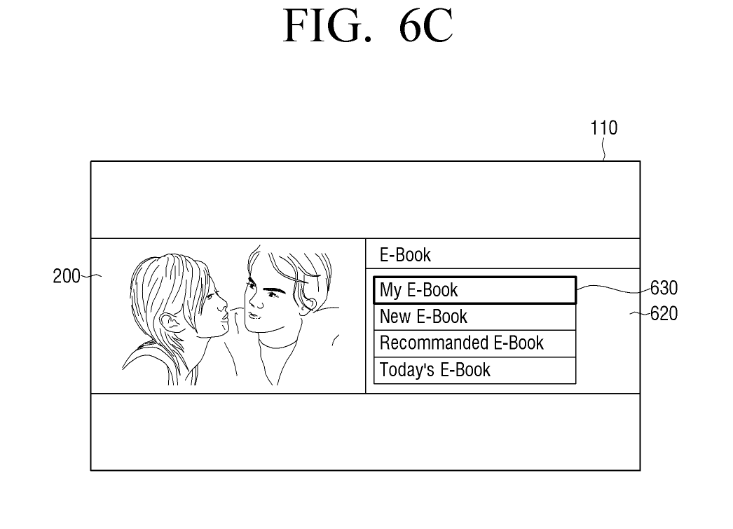

FIGS. 6A, 6B, and 6C are views illustrating a method of replacing the web page screen 300 that is displayed with another content or program simultaneously, according to an exemplary embodiment.

As described above, if a user command to display a plurality of contents is input from a user while a broadcast content is displayed, the controller 130 may display the broadcast content screen 200 on the left side and the web page screen 300 that is set to a default value on the right side of the broadcast content screen 200.

If a user command to change the web page screen 300 is input, the controller 130 may display a menu 600 including a content, a program, or an application that can be displayed in replacement of the web page screen 300 as illustrated in FIG. 6A.

In FIG. 6A, the menu 600 is displayed on the lower part of the display 110, but this is only an example. The controller 130 may display the menu 600 in consideration of the size of the display 110, the location of a displayed content, etc.

While a user selects one of the applications and programs displayed on the display 110, the controller 130 may display a highlight on the menu 600. If a user command to select an application or a program is input, the controller 130 may move the highlight according to the user command.

If a user command to select a menu is input while a highlight is displayed on an “E-Book” menu 610 as illustrated in FIG. 6A, the web page screen 300 is replaced with an “E-Book” screen 620 as illustrated in FIG. 6B.

The controller 130 may display the highlight on the “E-Book” screen 620 that is newly displayed by a user selection. In other words, the controller 130 may display the outline of the “E-Book” screen 620 in a thick line.

In addition, as described above, the controller 130 may adjust the depth of a highlight according to a user command. In other words, if a user command to select a content displayed inside the “E-Book” screen 620 is input, the controller 130 may display a highlight on controllable contents among the contents included in the “E-Book” screen 620.

For example, as illustrated in FIG. 6C, if a plurality of contents such as “My E-Book,” “New E-Book,” “Recommended E-Book,” and “Today's E-Book” are included in the “E-Book” screen 620, and a user command to press “Enter” button provided on a remote controller is input, the controller 130 may move the highlight to the content on the uppermost end of the contents. Accordingly, as illustrated in FIG. 6C, the thick line on the outline of the “E-Book” screen 620 may be released, and the outline of a “My E-Book” menu 630 may be highlighted in a thick line.

If the highlight is displayed on the “My E-Book” menu 630, and a user command to press the down direction button among the four direction buttons provided on a remote controller is input, the controller 130 may control the display 110 to release the highlight displayed on the “My E-Book” menu 630, and display the highlight on “New E-Book” menu.

If a user command to press the down direction button among the four direction buttons provided on the remote controller is input again, the controller 130 may control the display 110 to release the highlight displayed on the “New E-Book” menu, and display the highlight on “Recommend E-Book” menu.

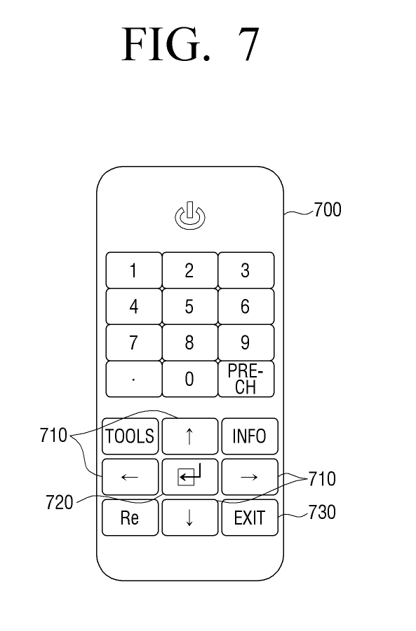

FIG. 7 is a view illustrating a control apparatus 700 to control the display apparatus 100, according to an exemplary embodiment. In other words, the control apparatus 700 such as a remote controller may include not only a plurality of number keys but also at least one direction key 710, an Enter key 720, and an Exit key 730.

The keys included in the control apparatus 700 may be realized in the form of a button, but this is only an example. The keys may be realized in the form of a touch UI, etc.

A user may move a highlight displayed on the display 110 using the direction key 710 of the control apparatus 700. In other words, a user may move the highlight to a content to be controlled by manipulating the direction key 710.

In addition, a user may adjust the depth of a highlight by using the Enter key 720 and the Exit key 730. In other words, the Enter key 720 may be used to move a highlight to a content that is included in a highlighted content. The Exit key 730 may be used to move a highlight to an upper content of a highlighted content.

If a content is displayed on the full area of the display 110, the controller 130 may control the display 110 to display a plurality of contents simultaneously according to a user command to press the Enter key 720.

If two contents are displayed, the controller 130 may control the display 110 to enlarge the highlighted content out of the two contents and display the highlighted content on the full area of the display 110.

However, using the Enter key 720 and the Exit key 730 to adjust the depth of a highlight is only an example, and a separate key may be used. In addition, the depth of a highlight may be adjusted by a touch input, a toggle key, a motion input through a touch pad, or an input using a pointing device.

To control the display apparatus 100, an application that provides a UI of the control apparatus 700 may be used. In other words, a user may download an application for controlling the display apparatus 100 and use a UI as illustrated in FIG. 7 by executing the downloaded application.

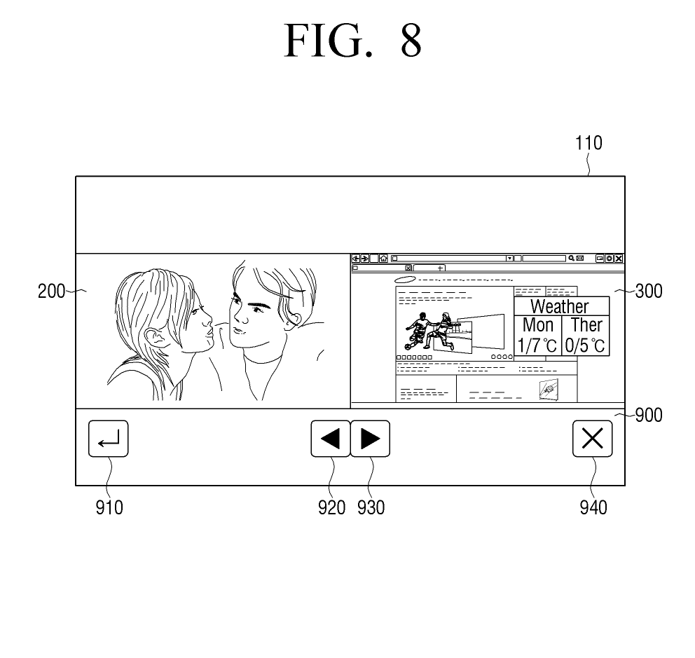

FIG. 8 is a view illustrating a control GUI 900 to control the display apparatus 100, according to an exemplary embodiment. In other words, the display apparatus 100 may display an Enter UI 910, left and right direction UIs 920, 930, and an Exit UI 940 on the area that does not cover a plurality of displayed contents 200, 300.

If the display 110 is realized as a touch panel, a user may move a highlight or adjust the depth of a highlight by directly touching the Enter UI 910, the left and right direction UIs 920, 930 and the Exit UI 940.

In addition, a user may select the Enter UI 910, the left and right direction UIs 920, 930 and the Exit UI 940 that are displayed by using an apparatus such as a pointing device remotely.

If a plurality of contents are displayed according to the above-described method, a user may not only select a content to be controlled by moving a displayed highlight but also adjust the screens of the plurality of contents.

For example, in FIG. 8, if the outline of the broadcast content 200 is displayed in a thick line and the Exit UI 940 is selected, the controller 130 may control to increase the size of the area of the broadcast content 200 gradually according to the number of selections of the Exit UI 940. In other words, the controller 130 may control such that the size of the area of the broadcast content 200 increases gradually as the Exit UI 940 is selected repeatedly, and when the Exit UI 940 is selected for the fifth time, the broadcast content 200 is displayed on the full area of the display 110.

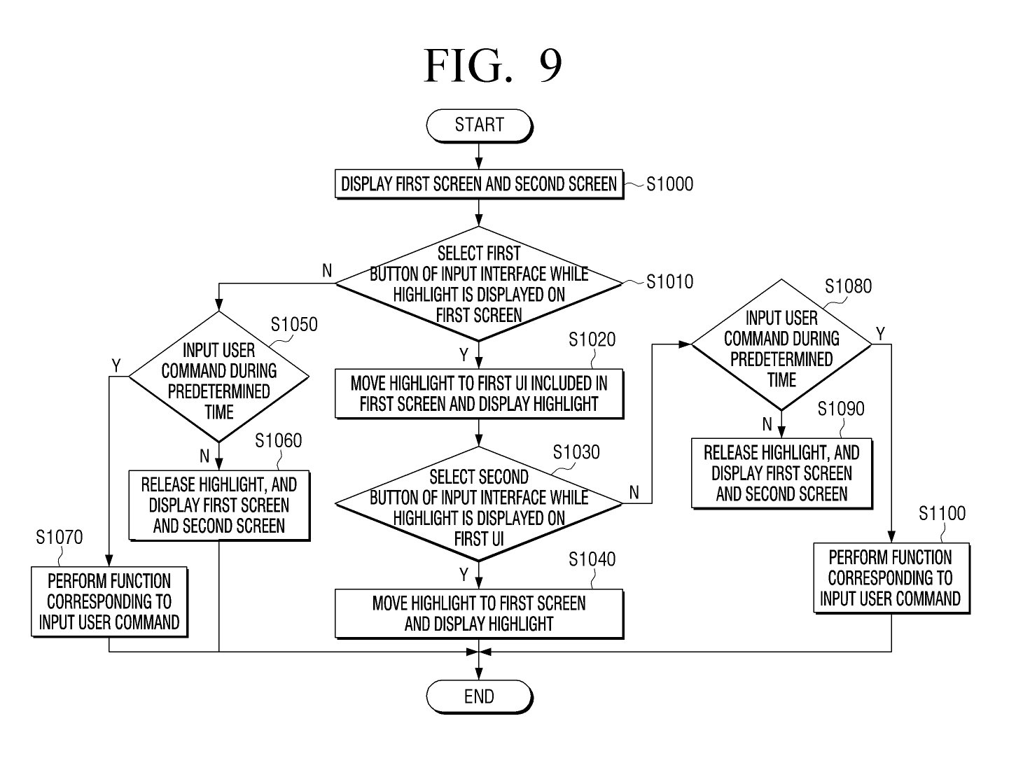

FIG. 9 is a flowchart illustrating a displaying method of the display apparatus 100, according to an exemplary embodiment.

In operation 51000, the display apparatus 100 displays the first screen and the second screen through the display 110. In other words, if a user command to display two images is input while the first screen is displayed, the display apparatus 100 may display two contents simultaneously.

The user command to display two images may be input by selecting a button that is provided on a control apparatus to control the display apparatus 100. For example, if a button such as “mode” is provided on a remote controller, a user may change the current mode to a mode in which the display apparatus 100 displays a plurality of images by pressing the “mode” button at least once.

Alternatively, the display apparatus 100 may display an OSD window. Accordingly, a user may change the current mode to a mode in which the display apparatus 100 displays two images through the displayed OSD window.

If a user command to display two contents is input while the first screen is displayed according to the above-described method, the display apparatus 100 may control to display the first screen and the second screen on the display simultaneously.

The display apparatus 100 may display a highlight on the first screen that has been displayed before the user command to display a plurality of contents is input. For example, the display apparatus 100 may display a highlight by displaying the outline of the first screen in a thick line. However, displaying the outline of a screen in a thick line is only an example, and the display apparatus 100 may display a highlight by applying a visual effect such that the first screen seems to be protruded from the display or by displaying an indicator around the first screen.

If a user command to display a plurality of contents such as a web page, a predetermined program or a predetermined application is input, the display apparatus 100 may set the first screen to be displayed along with the second screen.

Alternatively, if a user command to display a plurality of contents is input, the display apparatus 100 may display an application or a program that has been executed by a user most recently along with the first screen simultaneously.

A user may control a function with respect to the first screen while a highlight is displayed on the first screen. For example, if a user inputs a user command to control a channel or a volume through an input interface while a highlight is displayed on the first screen, the display apparatus 100 may adjust a channel or a volume of the first screen.

In addition, the display apparatus 100 may input a user command to adjust the depth of a highlight through an input interface.

In operation S1010, the display apparatus 100 determines whether the first button of the input interface is selected while a highlight is displayed on the first screen. In response to the display apparatus 100 determining that the first button of the input interface is selected while the highlight is displayed on the first screen, the display apparatus 100 continues in operation S1020. Otherwise, the display apparatus continues in operation S1050.

In operation S1020, the display apparatus 100 moves the highlight to the first UI included in the first screen, and displays the highlighted first UI.

In operation S1030, the display apparatus 100 determines whether the second button of the input interface is selected while a highlight is displayed on the first UI. In response to the display apparatus 100 determining that the second button of the input interface is selected while the highlight is displayed on the first UI, the display apparatus 100 continues in operation S1040. Otherwise, the display apparatus continues in operation S1080.

In operation S1040, the display apparatus 100 moves the highlight to the first screen, and displays the highlighted first screen.

If the selectable or controllable second UI exists in the first UI and the first button of the input interface is selected again, the display apparatus 100 may move the highlight to the second UI included in the first UI, and display the highlighted second UI.

If the second button of the input interface is selected while a highlight is displayed on the second UI, the highlight may be moved to the first UI. If the second button of the input interface is selected while the highlight is displayed on the first UI, the highlight may be moved to the first screen.

In operation S1080, the display apparatus 100 determines whether a user command is input during a predetermined time period (for example, 10 seconds) while a highlight is displayed on the first UI. In response to the display apparatus 100 determining that the user command is input during the predetermined time period, the display apparatus 100 continues in operation S1100. Otherwise, the display apparatus 100 continues in operation S1090.

In operation S1090, the display apparatus 100 releases the highlight, and displays the first screen and the second screen.

In operation S1100, the display apparatus 100 performs a function corresponding to the input user command. In other words, the display apparatus 100 may perform a function corresponding to the input user command with respect to the highlighted first UI.

In operation S1050, the display apparatus 100 determines whether a user command is input for a predetermined time period (for example, 10 seconds) while a highlight is displayed on the first screen. In response to the display apparatus 100 determining that the user command is input during the predetermined time period, the display apparatus 100 continues in operation S1070. Otherwise, the display apparatus 100 continues in operation S1060.

In operation S1060, the display apparatus 100 releases the highlight, and displays the first screen and the second screen. For example, if the first screen and the second screen are displayed simultaneously according to a user manipulation, and no user command is input for a predetermined time period (for example, 10 seconds), the display apparatus 100 may release the highlighted that is displayed on the first screen.

In operation S1070, the display apparatus 100 performs a function corresponding to the input user command. In other words, the display apparatus 100 may perform a function corresponding to the input user command with respect to the highlighted first screen.

The first button in FIG. 9 may be an “Enter” key provided in the input interface, and the second button may be an “Exit” key provided in the input interface.

In addition, if a user command to press the second button (for example, an “Exit” key) is input while a highlight is displayed on the first screen, the display apparatus 100 may control to enlarge the first screen and display the first screen on the full area of the display.

If the first screen is enlarged, and a user command to press the first button (for example, an “Enter” key) is input again within a predetermined time period, the display apparatus 100 may display the first screen and the second screen simultaneously. In this case, the size of the first screen and the second screen may be the same.

According to the above-described displaying method of the display apparatus 100, when the display apparatus 100 displays a plurality of contents, a user may select a content to be controlled easily. In addition, the user may control a content that is selected among a plurality of contents easily.

While not restricted thereto, an exemplary embodiment can be embodied as computer-readable code on a computer-readable recording medium. For example, a control program that controls the above-described operations may be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more units can include circuitry, a processor, a microprocessor, etc., and may execute a computer program stored in a computer-readable medium.

The foregoing exemplary embodiments and advantages are examples and are not to be construed as limiting. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A display apparatus, comprising:
a display configured to display a first screen, a second screen, and a highlight on the first screen, the first screen comprising a first user interface (UI);
an input interface configured to receive a first selection of a first button of the input interface, and a second selection of a second button of the input interface; and
a controller configured to:
in response to the input interface receiving the first selection of the first button while the highlight is displayed on the first screen, control the display to display the highlight on the first UI; and
in response to the input interface receiving the second selection of the second button while the highlight is displayed on the first UI, control the display to display the highlight on the first screen.

2. The apparatus as claimed in claim 1, wherein the controller is further configured to, in response to the input interface receiving the second selection of the second button while the highlight is displayed on the first screen, control the display to enlarge a size of the first screen, and display the enlarged first screen on a full area of the display.

3. The apparatus as claimed in claim 1, wherein the first UI comprises a second UI, and
the controller is further configured to, in response to the input interface receiving the first selection of the first button while the highlight is displayed on the first UI, control the display to display the highlight on the second UI.

4. The apparatus as claimed in claim 1, wherein the input interface is further configured to receive a control command, and
the controller is further configured to:
in response to the input interface receiving the control command while the highlight is displayed on the first screen, perform a function corresponding to the control command with respect to the first screen; and
in response to the input interface receiving the control command while the highlight is displayed on the first UI, perform the function with respect to the first UI.

5. The apparatus as claimed in claim 1, wherein the input interface is further configured to receive a command to move the highlight, and
the controller is further configured to, in response to the input interface receiving the command to move the highlight while the highlight is displayed on the first screen, control the display to display the highlight on the second screen.

6. The apparatus as claimed in claim 5, wherein the second screen comprises another UI, and
the controller is further configured to:
in response to the input interface receiving the first selection of the first button while the highlight is displayed on the second screen, control the display to display the highlight on the other UI; and
in response to the input interface receiving the second selection of the second button while the highlight is displayed on the other UI, control the display to display the highlight on the second screen.

7. The apparatus as claimed in claim 1, wherein the input interface is further configured to receive a command to display the first screen and the second screen simultaneously, and
the controller is configured to, in response to the input interface receiving the command to display the first screen and the second screen simultaneously while the first screen is displayed on a full area of the display, control the display to display the first screen and the second screen simultaneously, and display the highlight on the first screen.

8. The apparatus as claimed in claim 1, wherein the input interface is further configured to receive a command to display the first screen and the second screen simultaneously, and
the controller is configured to, in response to the input interface receiving the command to display the first screen and the second screen simultaneously while the first screen is displayed on a full area of the display and the highlight is displayed on the first UI, control the display to display the first screen and the second screen simultaneously, and display the highlight on the first UI.

9. The apparatus as claimed in claim 1, wherein the input interface comprises an external control apparatus configured to control the display apparatus, and
the first button and the second button are at least one among toggle buttons, key buttons, and touch buttons on the external control apparatus.

10. The apparatus as claimed in claim 1, wherein the input interface is further configured to receive a command to change the second screen,
the controller is further configured to, in response to the input interface receiving the command to change the second screen, control the display to display a menu and the highlight on the menu,
the input interface is further configured to receive a command to select the menu, and
the controller is further configured to, in response to the input interface receiving the command to select the menu while the highlight is displayed on the menu, control the display to display a third screen.

11. A displaying method of a display apparatus, the displaying method comprising:
displaying a first screen, a second screen, and a highlight on the first screen, the first screen comprising a first user interface (UI);
in response to receiving a first selection of a first button of an input interface while the highlight is displayed on the first screen, displaying the highlight on the first UI; and
in response to receiving a second selection of a second button of the input interface while the highlight is displayed on the first UI, displaying the highlight on the first screen.

12. The method as claimed in claim 11, further comprising:
in response to receiving the second selection of the second button while the highlight is displayed on the first screen, enlarging a size of the first screen, and displaying the enlarged first screen on a full area of the display.

13. The method as claimed in claim 11, wherein the first UI comprises a second UI, and
the method further comprises, in response to receiving the first selection of the first button while the highlight is displayed on the first UI, displaying the highlight on the second UI.

14. The method as claimed in claim 11, further comprising:
in response to receiving a control command while the highlight is displayed on the first screen, performing a function corresponding to the control command with respect to the first screen; and
in response to receiving the control command while the highlight is displayed on the first UI, performing the function with respect to the first UI.

15. The method as claimed in claim 11, further comprising:
in response to receiving a command to move the highlight while the highlight is displayed on the first screen, displaying the highlight on the second screen.

16. The method as claimed in claim 15, wherein the second screen comprises another UI, and
the method further comprises:
in response receiving the first selection of the first button while the highlight is displayed on the second screen, displaying the highlight on the other UI; and
in response to receiving the second selection of the second button while the highlight is displayed on the other UI, displaying the highlight on the second screen.

17. The method as claimed in claim 11, wherein the displaying the first screen and the second screen comprises, in response to receiving a command to display the first screen and the second screen simultaneously while the first screen is displayed on a full area of the display, displaying the first screen and the second screen simultaneously, and displaying the highlight on the first screen.

18. The method as claimed in claim 11, wherein the displaying the first screen and the second screen comprises, in response to receiving a command to display the first screen and the second screen simultaneously while the first screen is displayed on a full area of the display and the highlight is displayed on the first UI, displaying the first screen and the second screen simultaneously, and displaying the highlight on the first UI.

19. The method as claimed in claim 11, wherein the input interface comprises an external control apparatus configured to control the display apparatus, and
the first button and the second button are at least one among toggle buttons, key buttons, and touch buttons on the external control apparatus.

20. The method as claimed in claim 11, further comprising:
in response to receiving a command to change the second screen, displaying a menu and the highlight on the menu; and
in response to receiving a command to select the menu while the highlight is displayed on the menu, displaying a third screen.
